(19) United States
(12) Patent Application Publication
(10) Pub. No.: US 2017/0028686 A1
(43) Pub. Date: Feb. 2, 2017

(54) DURABLE AND LIGHTWEIGHT GLAZING UNITS

(71) Applicants: Edward L. Wilson, Morrice, MI (US); Michael D. Broekhuis, Wyoming, MI (US); Harlan J. Byker, West Olive, MI (US)

(72) Inventors: Edward L. Wilson, Morrice, MI (US); Michael D. Broekhuis, Wyoming, MI (US); Harlan J. Byker, West Olive, MI (US)

(73) Assignee: Pleotint, L.L.C., West Olive, MI (US)

(21) Appl. No.: 15/223,628

(22) Filed: Jul. 29, 2016

Related U.S. Application Data
(60) Provisional application No. 62/198,380, filed on Jul. 29, 2015.

(51) Int. Cl. B32B 17/10; E06B 3/66; B32B 17/06; B32B 7/14; G02F 1/1339; B32B 27/36; B32B 27/40; G02F 1/1334; G02F 1/1343; E06B 3/663; B32B 27/08

(52) U.S. Cl. CPC B32B 17/1055; E06B 3/66309; E06B 3/6617; B32B 17/06; B32B 7/14; B32B 17/10733; B32B 17/1077; B32B 27/08; B32B 27/36; B32B 27/40; G02F 1/1334; G02F 1/13439; G02F 1/1339; E06B 2009/2417

(57) ABSTRACT

An environmentally durable window glass unit is provided with improved edge sealing to protect the interlayer of one or more laminates that make up the unit. The insulated glass unit includes a first pane comprising an outboard glass sheet, an inboard sheet and an interlayer therebetween. The inboard sheet is smaller in length and/or width than the outboard sheet. The glass unit also includes a second pane spaced away from and sealed to the first pane. A gas space is located between the inboard sheet of the first pane and the second pane. A spacer is positioned between the first pane and the second pane. The spacer is adhered to the inboard sheet of the first pane and to the second pane with a primary seal. A second seal adheres the outboard sheet of the first pane to the second pane.

### CROSS-REFERENCES

This application claims the benefit of U.S. Provisional Application No. 62/198,380, filed Jul. 29, 2015.

### TECHNICAL FIELD

This invention relates to environmentally durable and to lightweight, environmentally durable glazing units or window glass units including those comprising laminates. The window units of interest are any type of multi-pane window unit. The multi-pane window units optionally include single laminates, dual or double laminates, safety glass laminates, hurricane impact resistant glazing units, laminates with thermochromic (“TC”), electrochromic (“EC”), photochromic (“PC”), polymer dispersed liquid crystals (“PDLC”), or suspended particle device (“SPD”) layers, and any combination these dynamic window technologies on a pane, in a pane, or in one or more laminates of a window glass unit including laminate-containing window glass units used in butt glazing applications and any combination thereof. The invention relates to special methods of edge sealing and protecting the window units themselves, the interlayers in the laminates, and dynamic window technology layers which may be part of the multi-pane window glass units.

### BACKGROUND

U.S. Pat. No. 7,817,328 to Millett et.al. describes window glass units comprising a laminate which may be edge sealed. An improvement on this approach is described here.

Glazing or window glass units are often double or triple pane units in which panes are separated by gas or vacuum spaces and are often referred to as insulated glass units (“IGUs”). IGUs typically have a spacer that goes all the way around the perimeter or near the perimeter of the unit to space the panes apart and to maintain the gas or vacuum and the spacing between the panes. The gas space may contain air or low thermal conductivity gases like argon, krypton or sulfur hexafluoride or may contain an aerogel or may be evacuated to remove most of the gas. In the case of a vacuum, additional spacers are used in the view of the window to maintain spacing between the panes. The perimeter spacer is typically made from aluminum, stainless steel, polymeric material(s) or some combination thereof. The spacer is typically adhered to the panes with a primary seal which may be butyl rubber, polyisobutylene, silicone, polysulfide, thermosets like epoxies, thermoplastics or various other materials and is preferably a continuous bead or layer of polyisobutylene all the way around the perimeter on both sides of the spacer. The spacer and the primary seal are backed up or chased with a secondary seal which typically provides additional sealing for the gas or vacuum space and increased structural integrity for the window glass glazing unit. Typical secondary seal materials are polysulfides, silicones, polyisobutylene or some type of butyl rubber.

Laminates for window panes are often made from two sheets of glass bonded to together with an interlayer or a combination of interlayers and other layers like those of a PDLC device or SPD. The interlayers themselves may contain chromogenic materials. A laminate may be one of the panes of a multi-pane window and for the purposes of this invention a laminate is considered as a single pane even though it may comprise two sheets of glass bonded together with an interlayer or a series of layers including interlayers. One or more than one pane of a multi-pane window may be a laminate but each individual laminate is still considered to be a one single pane.

The process of making laminates often involves placing an interlayer sheet or film with rough surface texture on both surfaces of the interlayer on top of a first sheet of glass. This is followed by laying a second sheet of glass on the interlayer. This assembly is then heated and pressed to form a largely de-aired and “sealed around the perimeter” pre-laminate. This sealing around the perimeter means that the surface texture of the interlayer has been largely pressed out and gas is no longer free to enter between the glass and the interlayer during further processing. This seal is different than an edge seal provided by a separate edge sealant material(s) even if the edge sealant material(s) is similar to the interlayer material. It is a seal formed simply between the glass and the interlayer sheet itself near or at the perimeter of the pre-laminate. Initially the rough surface texture helps with the de-airing and the pressing is provided by heating the assembly in a vacuum bag or vacuum press apparatus or by passing the heated assembly through nip or pinch rollers. While this tacking process largely de-airs the pre-laminate, further heating, generally under pressure, in a vacuum bag or press or an autoclave is usually required for final de-airing to give a finished laminate. This heating, generally, under pressure, is believed to drive very small amounts of still trapped air permanently into solution in the bulk of the interlayer polymeric material to give a finished laminate without any of the frosted appearance leftover from the rough surface texture of the interlayer.

The interlayers used for making window glass laminates are typically sheets or films of polyvinylbutyral (“PVB”), ethylenevinylacetate (“EVA”), silicone, thermoplastic polyurethane (“TPU”), or an ionomer copolymer of ethylene and methacrylic acid in which some or all of the hydrogen ions of the methacrylic acid groups are replaced with lithium, sodium or zinc ions. The interlayer may comprise multiple layers including a trilayer with one layer of PVB bonded on a first side of a polyester or poly(ethylene terephthalate) (“PET”), separator and another layer of PVB bonded on the second side of the polyester or PET separator. The interlayer may comprise multiple layers including a layer of PVB, TPU or EVA, a layer of PET coated with a transparent conductive layer, a layer of PDLC or SPD, another layer of PET coated with a transparent conductive layer and a layer of PVB, TPU or EVA. The interlayer or one of the layers of a multilayer interlayer may comprise chromogenic materials like photochromic or especially thermochromic materials. In some cases the edges of laminates may be susceptible to environmental degradation because of exposure of unprotected edges to humidity, liquid water, oxygen and/or environmental contaminants. This susceptibility is especially true if the interlayer comprises chromogenic materials or other dynamic window technologies. There is a desire to protect the edges of laminates from this type of degradation and the present inventions provides novel ways to seal the edges of laminates in a cost effect manner as part of the manufacture of glazing units.

### SUMMARY OF THE INVENTION

In one aspect, an insulated glass unit comprises a first pane comprising an outboard glass sheet, an inboard sheet and an interlayer there between, wherein the inboard sheet is smaller in length and/or width than the outboard sheet and a second pane spaced away from and sealed to the first pane, a gas space between the inboard sheet of the first pane and the second pane, a spacer positioned between the first pane and the second pane, wherein the spacer is adhered to the inboard sheet of the first pane and to the second pane with a primary seal and a second seal that adheres the outboard sheet of the first pane to the second pane.

In another aspect, an insulated glass unit comprises a first pane comprising an outboard glass sheet, an inboard sheet and an interlayer there between, wherein the inboard sheet is smaller in length and width than the outboard sheet and a second pane spaced away from and sealed to the first pane, a gas space between the inboard sheet of the first pane and the second pane, a spacer positioned between the first pane and the second pane, wherein the spacer is adhered to the outboard sheet of the first pane and to the second pane with a primary seal and a second seal that adheres the outboard sheet of the first pane to the second pane.

In another aspect, an insulated glass unit comprises a first pane comprising an outboard glass sheet, an inboard sheet and an interlayer there between, wherein the inboard sheet is smaller in length and/or width than the outboard sheet, and a second pane comprising an outboard glass sheet, an inboard sheet and an interlayer there between, wherein the inboard sheet is smaller in length and/or width than the outboard sheet spaced away from and sealed to the first pane, a gas space between the inboard sheet of the first pane and the inboard sheet of the second pane, a spacer positioned between the first pane and the second pane, wherein the spacer is adhered to the inboard sheet of the first pane and to the inboard sheet of the second pane with a primary seal and a second seal that adheres the outboard sheet of the first pane to the outboard sheet of the second pane.

In still another aspect, a window glass unit or IGU comprises:

a. a first glass substrate;

b. a first thermochromic layer;

c. a separator for thermochromic layers;

d. a second thermochromic layer;

e. a second glass substrate;

f. a gas space;

g. a low-e coating;

h. a third glass substrate;

i. a first adhesive interlayer;

j. a first plastic substrate;

k. a first transparent conductor layer;

1. a liquid crystal comprising layer;

m. a second transparent conductor layer;

n. a second plastic substrate;

o. a second adhesive interlayer; and

p. a fourth glass substrate;

wherein the first and second glass substrates are independently selected from chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the third and fourth glass substrates are independently selected from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the first and second thermochromic layers comprise at least two different ligand exchange thermochromic materials and/or systems and wherein the separator for thermochromic layers is selected from a layer of polyester, polyethylene terephthalate, polyethylene naphthalate, acrylic, glass and cyclic olefin polymer or copolymer and wherein the gas space comprises air, nitrogen, argon, krypton, sulfur hexafluoride and/or carbon dioxide and wherein the low-e coating comprises a transparent metal oxide layer and/or thin layers of silver or silver alloys and wherein the first and second adhesive interlayers are independently selected from polyvinylbutyral, thermoplastic polyurethane, ethylene vinyl acetate, ionomers and ionomers comprising metal ions and silicone and wherein the a first and second plastic substrates are independently selected from layers of polyester, polyethylene terephthalate, polyethylene naphthalate, acrylic and cyclic olefin polymer or copolymer and wherein the first and second transparent conductor layers are independently selected from one layer or a stack of layers of fluorine doped tin, fluorine doped zinc oxide, tin doped indium oxide (ITO), aluminum doped zinc oxide, silver and alloys of silver and wherein the liquid crystal comprising layer comprises cholesteric and/or nematic liquid crystals in droplets or small domains within a polymer matrix or network and where the window glass unit structure may provide sealing opportunities as shown in FIGS. 3 and 4b and wherein the thermochromic layers provide UV barrier protection for the liquid crystal containing layer and the low-e coating provides a heat barrier for the overheating of the PDLC device which compromises its performance.

### BRIEF DESCRIPTION OF THE DRAWINGS

The following key identifies elements of the figures below:
10—outboard glass sheet
20—interlayer
30—inboard glass sheet
40—gas space
50—IGU primary seal
60—spacer
70—IGU secondary seal
100—interlayer primary seal and IGU secondary seal
110—second interlayer
120—interlayer primary seal
130—interlayer secondary seal and IGU secondary seal
140—ledge
150—interlayer primary seal and IGU secondary seal
160—interlayer secondary seal and IGU tertiary seal
170—thin annealed inboard glass sheet
180—gap between annealed glass and spacer
190—interlayer primary seal with edge capture of glass.

FIG. 1 is a partial cross-sectional view of a typical IGU having a laminate as one of the panes;

FIG. 2 is a partial cross-sectional view of an improved IGU according to one embodiment;

FIG. 3 is a partial cross-sectional view of an improved IGU according to a second embodiment;

FIG. 4a is a partial cross-sectional view of an improved IGU according to a third embodiment;

FIG. 4b is a partial cross-sectional view of an improved IGU according to a fourth embodiment;

FIG. 5a is a top view of a laminate according to an aspect of the invention;

FIG. 5b is a cross-sectional side view of the laminate of FIG. 5a;

FIG. 6a is a partial cross-sectional side view of an improved IGU according to a fifth embodiment;

FIG. 6b is a partial cross-sectional side view of an improved IGU according a sixth embodiment;

FIG. 7 is a partial cross-sectional side view of an improved IGU according a seventh embodiment;

FIG. 8 is a partial cross-sectional side view of an improved IGU according an eighth embodiment;

FIG. 9 is cross-sectional side view of a laminate according to another aspect of the invention.

### DETAILED DESCRIPTION

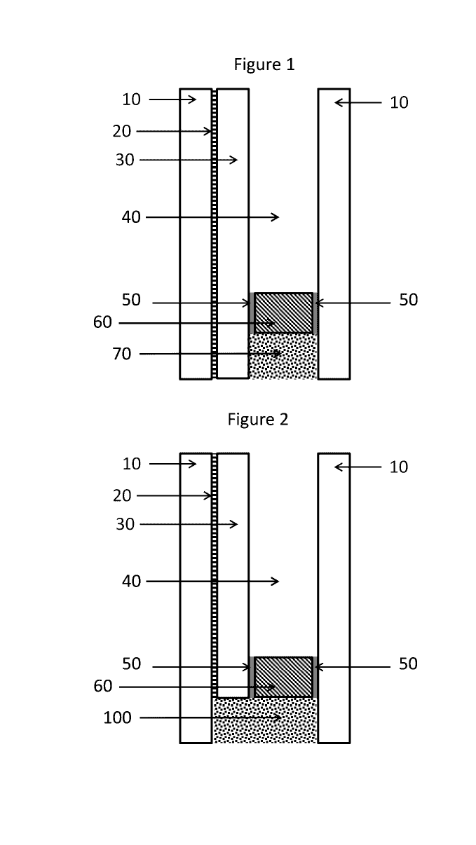

Typically a double pane IGU with a laminate as one of the panes would have a structure as shown in the partial cross-sectional view in FIG. 1. In this figure the interlayer around the edge of the laminate would be exposed to the environment as much as the edge of the IGU is exposed. Framing that contains the IGU often does not provide much protections from environmental conditions and occasionally may even trap moisture or liquid water to the point where the laminate and hence the interlayer at edge of IGU is literally standing in water.

An improved durability design is shown in the partial cross-sectional view of FIG. 2. Here the inboard sheet of glass of the laminate which is in contact with the gas space is smaller than the outboard sheet of glass of the laminate. The interlayer is typically similar in size to the inboard sheet of glass and is thus smaller than the outboard sheet of glass. This allows the secondary seal, 100, of the IGU to overcoat the edge of the interlayer and this allows seal, 100, to play the multiple roles of 1) a structural member bonding the two outboard sheets of glass together, 2) a secondary seal for the gas space and 3) a primary seal for the edge of the laminate and the interlayer of the laminate.

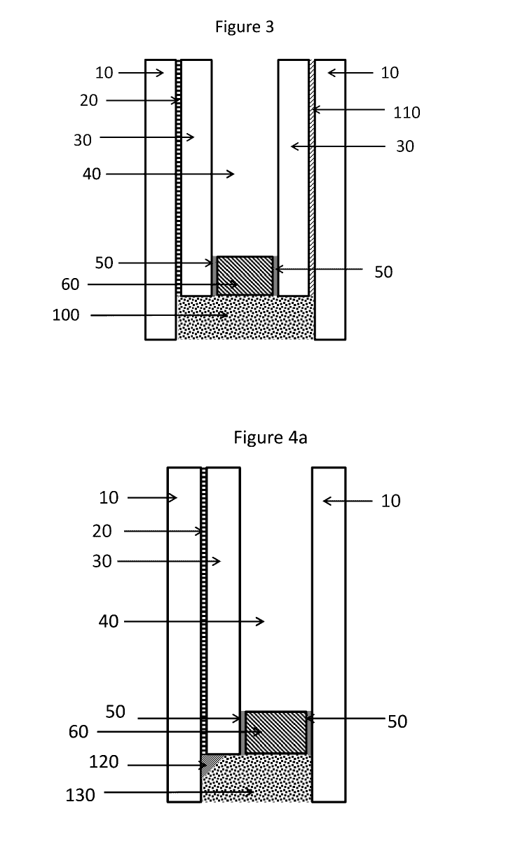

When the IGU has two laminates this idea may be extended to protecting the interlayers of both laminates which interlayers may be the same or different. This structure is shown in the partial cross-sectional view of FIG. 3. Here both inboard sheets of glass and the interlayers are smaller than the outboard sheets of glass and the secondary seal of the IGU, 100, provides environmental protection for both interlayers.

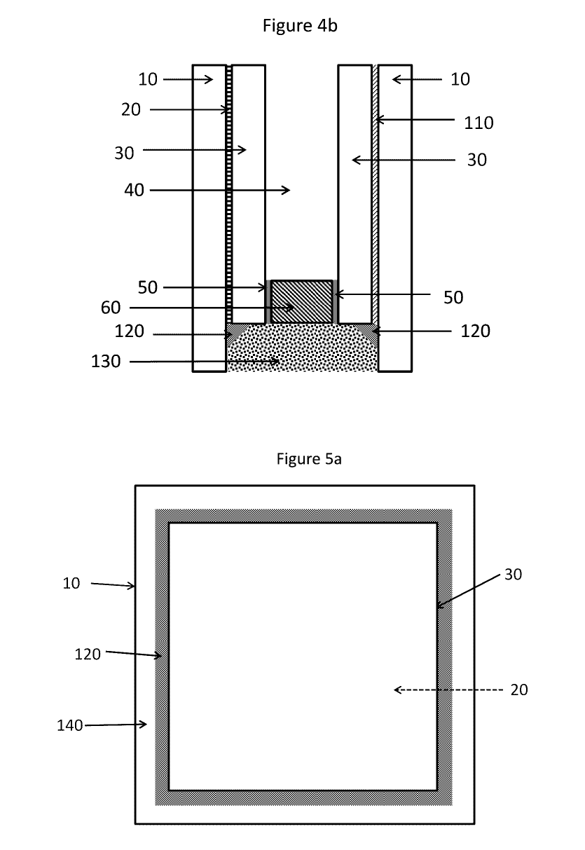

An improvement in environmental durability is achieved with the structures shown in the partial cross-sectional views of FIGS. 4a and 4b where a primary seal is provided for the interlayer itself and now the secondary seal for the IGU also serves as the secondary seal for the interlayer. The primary seal for the interlayer, 120, may take on the shape of a fillet or other shape or configuration. The primary seal for the interlayer may be any sealant materials known in the art of sealants but is preferable an flexible epoxy or a separate layer of material comprising butyl rubber, polysulfide, polyurethane or polyisobutylene.

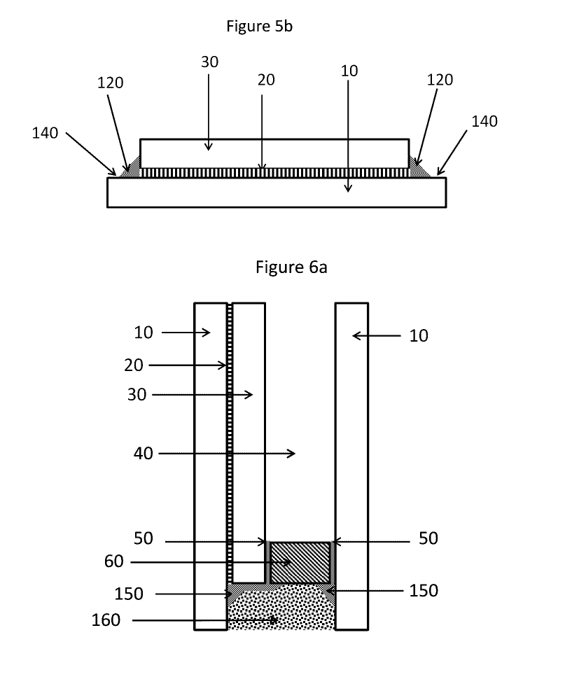

Since the inboard sheet or sheets of glass and the interlayer or interlayers are smaller than the outboard sheet or sheets this offset situation provides an excellent opportunity to place the primary seal for the interlayer on the ledge created by the larger sheet of glass as illustrated in the top view in FIG. 5a and cross sectional view in FIG. 5b of a laminate of the invention. This ledge will be around the entire exposed edge of the interlayer and the laminate if the inboard sheet of glass is smaller in both length and width and is placed so as to provide an offset all the way around the laminate.

This fortuitous situation of a ledge or offset allows thermoset materials, like two component epoxy, polysulfides, epoxide cured polysulfides and thermal set polyurethanes that are liquid or which even when thickened or thixotropic are tacky or sticky, to be applied to the exposed interlayer edge and directly contact and completely coat the interlayer edge. Then the laminate or pre-laminate may be racked in a horizontal or near horizontal fashion with the smaller sheet of glass facing up and the cure of the thermoset system may take place at elevated temperatures without having the thermoset material come in contact with the rack. This helps avoid the flowing or running of the thermoset sealant and avoids possible bonding of the laminate to the rack. Advantageously the cure of a thermoset interlayer edge seal may take place during the autoclave cycle of the final de-air of the pre-laminate to form the finished or final laminate. This combination of an offset ledge on which to place the sealant and the opportunity to process the pre-laminate for an hour or more at temperatures in excess of 120 C is a tremendous advantage for providing primary edge seals to give highly durable interlayer and laminates.

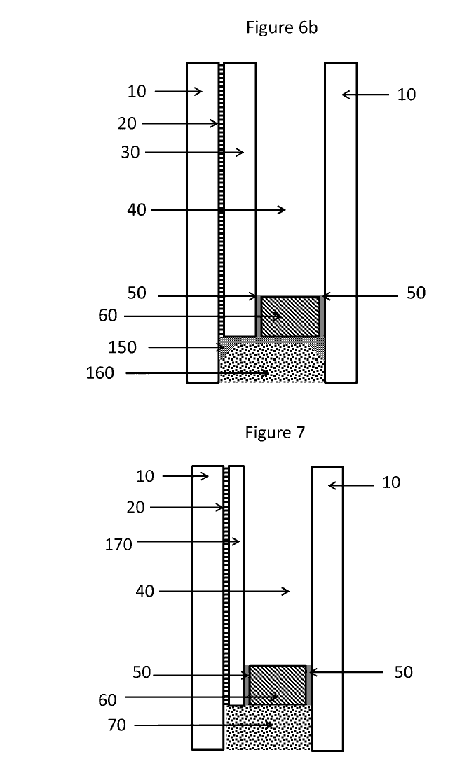

An alternative to dispensing or otherwise placing the interlayer primary seal as a fillet on the ledge as shown in FIGS. 5a and 5b is to dispense or place the interlayer primary seal across the IGU primary seal as shown in the partial cross sectional view of FIG. 6a or all the way across the spacer and IGU primary seal as shown in the partial cross sectional view of FIG. 6b. The gap or trough formed by bonding the panes together with the spacer and primary sealant provides a convenient space to place this sealant. This allows the interlayer primary seal to also function as an IGU secondary seal and then a tertiary IGU sealant can be applied over this IGU secondary sealant. These sealants are independently chosen from thermoplastic and thermoset materials however thermoset materials are preferred and the gap or the trough provides a protected space and environment for the thermoset materials during curing. It has been discovered that rigid and/or highly crosslinked thermoset materials used as primary and secondary seals, (120 in FIGS. 5a and 5b or 150 in FIGS. 6a and 6b), are not always compatible with the thermal expansion and contraction of the of the glass, the spacer, other seal materials and especially the thermal expansion and contraction of the interlayer materials used when at least one of the panes is a laminate. Preferred seal materials in these cases are flexibilized epoxies including epoxies wherein the epoxide groups are reacted with amine functionalities of polyamide curing agents and the number amine functional groups exceeds the number of epoxide groups. Also preferred are epoxy resins reacted with various curing agents including polysulfides.

The features shown in FIGS. 6a and 6b may be similarly included in other embodiments like 4b where there are multiple panes that are laminates.

When a sheet of glass in the laminate is tinted or the interlayer in the laminate is tinted or the interlayer is capable of becoming tinted by say a TC, PC and/or SPD phenomena, then the window pane may become very warm or hot when exposed to direct sunlight. Window glass temperatures in these cases readily reach 65 C and even up to or above 85 C on warm days in direct sunlight. If there is significant thermal stress build-up due, for example, to non-uniform heating during direct sunlight exposure then the glass sheets in the laminate may break. To minimize or prevent glass breakage due to thermal stress the glass is often tempered, heat strengthened, chemical strengthened or glass is used that has lower thermal expansion characteristics than normal soda-lime glass. However there are many cases where thin glass would have advantages because of cost, thickness and weight considerations. Thin glass is difficult to temper or heat strengthen also chemically strengthened glass and low thermal expansion glasses are expensive. Thus a way to allow annealed glass to be used without thermal stress breakage is of great advantage. If thin annealed glass is used in the offset structure of the present invention the thin annealed glass is cradled and edge protected by the sealants as shown in the partial cross-sectional view of FIG. 7. FIG. 7 only differs from FIG. 2 in that element 170 of FIG. 7 is thin annealed glass and element 30 of FIG. 2 is thicker and/or strengthened or low thermal expansion glass. The annealed glass, 170, in FIG. 7 is typically 3 millimeter thick or less and is preferably 2 millimeters thick or less.

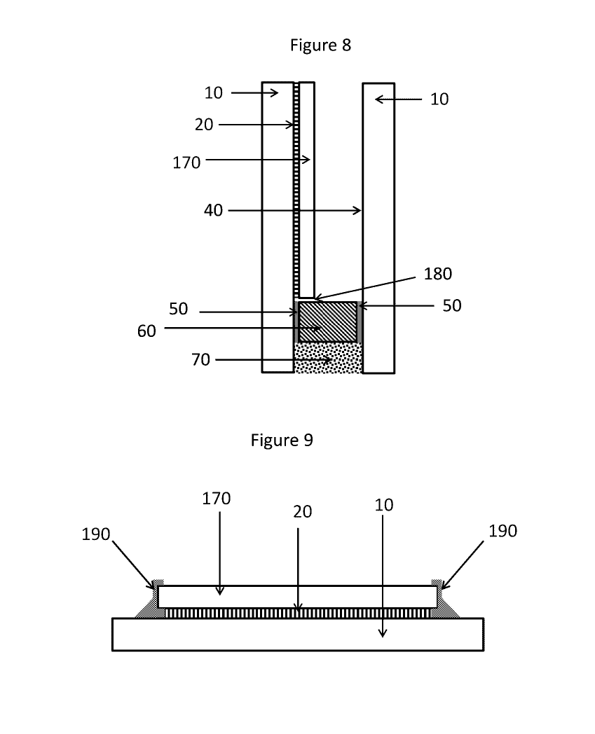

An additional improvement is realized when the thin annealed glass is suspended in the air space and is free to expand without being in contact with anything other than the gas space and the interlayer material as shown in the partial cross-sectional view of FIG. 8.

The inboard thin annealed glass embodiment may be similarly included in other embodiments, including but not limited to the embodiments of FIGS. 2, 3, 4a, 4b, 6a and 6b herein.

When the thin annealed glass is used as the inboard sheet of the laminate the thin annealed glass is not exposed to abuse during subsequent handling, further processing, shipping or installation. Neither the interlayer nor the thin annealed glass ever comes in direct contact with any framing materials. When using the configuration of FIG. 7, the thin annealed glass edge is in contact with the IGU secondary seal material which is preferably flexible and gives way during thermal expansion of the glass. Also the seal materials will bond to the glass and the chemical bonding process can strengthen the edges of the thin annealed glass against thermal breakage. In addition the thin annealed glass of the embodiments shown in FIGS. 7 and 8 is optionally edge worked, flame treated, laser cut and/or treated with chemical strengthening agents. Chemical strengthening agents include silane coupling agents, coupling agents which couple between nanotubes, nanowires or nanorods, including carbon nanotubes and defects in the glass surface and glass edges. They also include nanotubes, nanowires or nanorods, including carbon nanotubes which couple between polymers and/or polymer strengthening agents and the glass. The treatment of the thin annealed glass sheet may involve an amine terminated silane coupling agent followed by exposure to a bis-epoxide or bis-isocyanate which reacts with and bonds to one or more amine functional groups on the coupling agent. This allows strengthening of the glass surface and defects in the glass surface and edges.

The structure in FIG. 8 has the added advantage that the edges of the interlayer are only exposed to the dry and often inert or low oxygen atmosphere inside the gas space of the IGU. The spacer preferably contains desiccant that keeps the moisture content of the gas space particularly low and thus moisture doesn't enter the interlayer where the moisture could cause delamination or compromise the performance or durability of the TC, EC, PC, PDLC or SPD systems that are part of the interlayer.

A previously unforeseen advantage of the structure in FIG. 8, whether element 170 is thin annealed glass or not, is the distance between the chromogenic materials that are heated when exposed to direct sunlight and the frame in which the window glass unit of type shown in FIG. 8. This is especially important if the window frame is made out of vinyl such as polyvinylchloride with a relatively low softening point. It have been observed that in a few cases when dynamic or chromogenic window glass units are installed in vinyl frames, the frames get warm enough to soften and even start sagging. If the gap, 180, of FIG. 8 is between 2 and 50 millimeters and preferable between 4 millimeters 25 millimeters the heat generated in the interlayer is only poorly conducted along the outboard glass sheet or sheets, 10, to the frame material, (not shown). While the gap may be large enough to allow a non-tinting border on the window that is above the sight line of the frame, at least for sunlight responsive thermochromic interlayers this distance between the frame and the thermochromic interlayer minimizes the heat sink nature of the frame that causes the edges to be cooler and less tinted anyway. Also the contrast between the clear non-tinting border and the tint interlayer provides an excellent indicator that the interlayer over most of the window area is tinting to provide advantageous solar control performance.

In the structures of FIGS. 7 and 8 the thin annealed glass optionally has a low-e coating on the side of the glass facing the gas space. This low-e coating is preferably a soft coat low-e coating which comprises one, two, three or more layers of silver. This structure has the added advantage that the soft coat low-e coating does not have to go through a heat strengthening process which is more difficult with low-e coated glass and thus avoids another processing step with potential yield loss. It also gives the advantage of having the low-e coating on the side of the gas space that is closest to the building exterior and thus helps to give lower solar heat gain coefficients for these window glass units. Low-e coatings may be similarly included in other embodiments, including, but not limited to, the embodiments of FIGS. 2, 3, 4a, 4b, 6a and 6b herein.

In the case of an interlayer primary seal with a sheet of thin annealed glass in the laminate structure, the inventions may include a primary seal that captures or coats or encapsulates the edge of the thin annealed glass as shown in the cross sectional view in FIG. 9. Properly chosen interlayer primary seal materials like thermoset epoxies, especially flexible epoxy formulas, contain one or more than one silane coupling agent to help strengthen the edges of annealed glass and help prevent thermal stress breakage by coupling the cured epoxy to the glass and strengthen or essentially eliminate defects in the glass edge and surface of the cut edge of the glass. The laminate with the interlayer primary seal of FIG. 9 can be used in the IGU configuration of any of the FIG. 4a, 4b, 6a, 6b, 7 or 8.

The secondary and/or tertiary IGU seal or sealant of any of the window glass unit structures of the present disclosure may include desiccant(s) or water absorbing or water reactive materials. Preferred desiccants are calcium oxide, silica gels, or anhydrous sulfates of metals like sodium, calcium and magnesium. Preferred water reactive materials are acetals like 2,2-dialkoxypropane and derivatives thereof or analogous materials or orthoformates or orthoesters. This provides a secondary seal that further minimizes the ingress of water or water vapor into the IGU or into the interlayer by tying up the water in the sealant itself rather than allowing it to permeate through the sealant. The secondary and/or tertiary IGU seal or sealant of any of the window glass unit structures of the present disclosure may include stabilizers and/or anti-yellowing agents especially those disclosed in U.S. Pat. No. 8,623,243. The secondary and/or tertiary IGU seal or sealant of any of the window glass unit structures may contain fillers that increase the barrier properties of the seal or sealant to the diffusion of gases, contaminants and/or moisture.

The interlayer used in any of the window structures of the present inventions may have one or more than one layer. One or more than one of the layers of the interlayer may contain TC, PDLC, SPD and/or PC materials. The window structures may contain EC materials in contact with an ion conducting interlayer or in contact with the gas space within the window structures. U.S. Pat. Nos. 6,084,702; 6,446,402; 7,525,717; 7,538,931; 7,542,196; 7,817,328; 8,018,639; 8,154,788; 8,182,718; 8,431,045; 8,623,243; 9,011,734; 9,128,307 and 9,321,251 and published US Patent Applications 2014/0134367 and 2014/0327952 describe TC materials, systems, films, sheets and window structures for use in sunlight responsive thermochromic windows. The contents of these patents and patent applications are hereby incorporated by reference. The TC materials and systems in these patents have a desirable net increase in their ability to absorb UV, visible and/or NIR light energy as the temperature of the system increases and a net decrease in their ability to absorb UV, visible and/or NIR light energy as the temperature of the system decreases for temperatures within the active range of the systems. Preferably the change in absorption is continuously variable over the active temperature range of the system which for sunlight responsive thermochromic windows generally includes 25 C to 65 C. Preferred TC systems include ligand exchange thermochromic, (LETC), systems. Preferred LETC systems involve the temperature dependent change in the coordination environment of nickel and/or cobalt ions. The PC character of the interlayer may include the combination of PC and TC systems described in co-pending application US 2013/0286461, the contents of which are hereby incorporated by reference.

A preferred embodiment for the invention useful for hurricane impact resistant residential window glass units is described with reference to FIGS. 3 and 4b. In this embodiment interlayer 20 is a Suntuitive® thermochromic interlayer available from Pleotint, LLC of Jenison, Mich., the outboard sheet of glass in contact with the Suntuitive interlayer is heat strengthened or tempered, interlayer 110 is a sheet of TPU, EVA, PVB or ionomer sheet such as Sentry Glass Plus available from Kuraray America. Interlayer 110 is at least 0.0003 meter thick and the sheets of glass in contact with interlayer 110 are between 0.001 and 0.005 meter thick. The window unit is oriented so that interlayer 20 is closer to the outside of the structure or vehicle than interlayer 110. One of the inboard sheets of glass has a soft coat low-e coating on the surface facing the gas space. The spacer is used to bond the inboard sheets of glass of each laminate together with a primary seal as shown in FIGS. 3 and 4b. The primary seal, 50, is butyl rubber or polyisobutylene, and the secondary seal, 100 or 130, is butyl rubber, polyisobutylene, silicone or polysulfide.

### EXAMPLE 1

In accordance with FIG. 2, a 0.003 meter thick, 0.984 meters wide and 0.984 meters long glass sheet was heat strengthened on a conventional tempering furnace line. A 0.003 meter thick glass, 1.000 meter wide and 1.000 meter long sheet of glass was heat strengthened on a conventional tempering furnace line. The sheets of heat strengthened glass were laminated together with an approximately 0.985 meters wide and 0.985 meters long layer of Suntuitive® thermochromic interlayer available from Pleotint, LLC of Jenison, Mich. with the glass sheets positioned to provide a 0.008 meter wide offset or ledge in both width and length directions between the sheets of glass. A warm edge spacer about 0.011 meters thick was made from spacer material from Technoform Glass Insulation North America of Twinsburg, Ohio with the proper dimension for bonding the inboard sheet of the laminate to a 0.003 meter thick, 1.000 meter wide and 1.000 meter long sheet of double silver low-e coated glass. The low-e coating was edge deleted so that the spacer could be bonded to the uncoated glass surface rather than to the low-e coating. This minimizes the chances for corrosion of the low-e coating. A bead of polyisobutylene was applied to each side of the spacer and it was used to bond the inboard glass side of the laminate to the low-e coating deleted portion of the 0.003 meter thick sheet of glass with the low-e coating about 0.008 meters from the cut edge of the 0.003 low-e coated sheet of glass. This formed a gas space of about 0.011 meter thick between the laminate and the coated side of the low-e coated sheet of glass. The approximately 0.008 meter deep gap or trough between the cut edges of the outboard sheets of glass and the spacer was filled all the way around the IGU with two component polysulfide from Fenzi North America of Toronto, Ontario. Exposure to direct sunlight under conditions with significant thermal stress did not result in any glass breakage. The environmental durability was excellent for an exposure test to 90% relative humidity at 50 C for 100 hours and exposure to −40 C for 68 hours. The IGU survived over 60 such 168 hour cycles with no condensation appearance in the IGU, no delamination and no discoloration of the interlayer and only minimal loss of thermochromic performance of the interlayer near the edges of the laminate.

### EXAMPLE 2

A 0.003 meter thick, 0.984 meters wide and 0.984 meters long glass sheet was heat strengthened. A 0.003 meter thick glass, 1.000 meter wide and 1.000 meter long sheet of glass was heat strengthened. The sheets of heat strengthened glass were pre-laminated together in a nip roll tack process with a layer of Suntuitive® thermochromic interlayer available from Pleotint, LLC of Jenison, Mich. with the glass sheets positioned to provide a 0.008 meter wide offset in both width and length directions between the sheets of glass. This 0.008 meter offset provided an approximately 0.008 meter wide ledge. A two component polyamide epoxy containing silane coupling agents was mixed together with fumed silica to thicken the epoxy. A bead of this epoxy mixture was applied to the interlaying in the form of a fillet like that shown in FIG. 5. This assembly was racked in a horizontal fashion with the rack only touching the bottom, larger sheet of glass. The assembly was placed in an autoclave at high pressure and the temperature was raised above 135 C for more than 2 hours. The laminate emerged from the autoclave with the epoxy cured and the interlayer fully de-aired. A warm edge spacer about 0.011 meters thick was made spacer material from Technoform Glass Insulation North America of Twinsburg, Ohio with the proper dimension for bonding the inboard sheet of the laminate to a 0.003 meter thick, 1.000 meter wide and 1.000 meter long sheet of double silver low-e coated glass. A bead of polyisobutylene was applied to each side of the spacer and it was used to bond the inboard glass side of the laminate to the low-e coating side of the 0.003 meter thick sheet of glass about 0.008 meters from the cut edge of the 0.003 low-e coated sheet of glass. This formed a gas space of about 0.011 meter thick between the laminate and the coated side of the low-e coated sheet of glass. The approximately 0.008 meter deep gap or trough between the cut edges of the outboard sheets of glass and the spacer was filled all the way around the IGU with two component silicone from Dow Corning of Midland, Mich. Exposure to direct sunlight under conditions with significant thermal stress did not result in any glass breakage. The environmental durability was excellent for an exposure test to 90% relative humidity at 50 C for 100 hours and exposure to −40 C for 68 hours. The IGU survived more than 60 such 168 hour cycles with no condensation appearance in the IGU, no delamination and no discoloration of the interlayer and no loss of thermochromic performance of the interlayer near the edges of the laminate.

### EXAMPLE 3

A 0.003 meter thick, 0.984 meters wide and 0.984 meters long glass sheet was heat strengthened. A 0.003 meter thick glass, 1.000 meter wide and 1.000 meter long sheet of glass was heat strengthened. The sheets of heat strengthened glass were laminated together with a layer of Suntuitive® thermochromic interlayer available from Pleotint, LLC of Jenison, Mich. with the glass sheets positioned to provide a 0.008 meter wide offset or ledge in both width and length directions between the sheets of glass. A warm edge spacer about 0.011 meters thick was made from spacer material from Technoform Glass Insulation North America of Twinsburg, Ohio with the proper dimension for bonding the inboard sheet of the laminate to a 0.003 meter thick, 1.000 meter wide and 1.000 meter long sheet of double silver low-e coated glass. The low-e coating was edge deleted so that the spacer could be bonded to the uncoated glass surface rather than to the low-e coating. A bead of polyisobutylene was applied to each side of the spacer and it was used to bond the inboard glass side of the laminate to the low-e coating deleted portion of the 0.003 meter thick sheet of glass with the low-e coating about 0.008 meters from the cut edge of the 0.003 meter thick low-e coated sheet of glass. This formed a gas space of about 0.011 meter thick between the laminate and the coated side of the low-e coated sheet of glass. The bottom of the approximately 0.008 meter deep gap or trough between the outboard sheets of glass was coated with a layer of two component polyamide epoxy containing silane coupling agents that was mixed together with powdered glass as a filler and fumed silica to thicken the epoxy. The epoxy formed a continuous layer from the outboard sheet of glass of the laminate, over the interlayer, over the edge of the inboard sheet of glass of the laminate, over the first primary seal of the IGU, over the spacer, over the other primary seal of the IGU and up to an in contact with the glass that was coated with the low-e coating. The rest of the gap or trough was filled all the way around the IGU with two component polysulfide from Fenzi North America of Toronto, Ontario applied directly over the epoxy layer. The epoxy and the polysufide were both allowed to cure at room temperature for several days.

### EXAMPLE 4

A 0.003 meter thick, 0.984 meters wide and 0.984 meters long annealed glass sheet was heat strengthened. A 0.003 meter thick glass, 1.000 meter wide and 1.000 meter long sheet of glass was heat strengthened. The sheets of heat strengthened glass were laminated together with a layer of Suntuitive® thermochromic interlayer available from Pleotint, LLC of Jenison, Mich. with the glass sheets positioned to provide a 0.008 meter wide offset or ledge in both width and length directions between the sheets of glass. A 0.003 meter thick, 0.984 meters wide and 0.984 meters long double silver low-e coated annealed glass was laminated to a 0.003 meter thick glass, 1.000 meter wide and 1.000 meter long sheet of annealed glass with an interlayer of approximately 0.0015 meters thick SGP from Kuraray America with the glass sheets positioned to provide a 0.008 meter wide offset or ledge in both width and length directions between the sheets of glass and the low-e coating on the exposed surface. A warm edge spacer about 0.011 meters thick was made from spacer material from Technoform Glass Insulation North America of Twinsburg, Ohio with the proper dimension for bonding the inboard sheets of the laminates together. A bead of polyisobutylene was applied to each side of the spacer and it was used to bond to the inboard glass sides of the laminates as shown in FIG. 3. This formed a gas space of about 0.011 meter thick between the laminates. The approximately 0.008 meter deep gap or trough between the cut edges of the outboard sheets of glass of the laminates and the spacer was filled all the way around the IGU with two component polysulfide from Fenzi North America of Toronto, Ontario which provided edge seal protection for the interlayers of both laminates. The window glass unit was suitable for butt glazing in a framing system and suitable for providing excellent durability, excellent solar control based on the sunlight responsive tinting of the thermochromic layer and hurricane impact resistance based on the double laminate construction.

### EXAMPLE 5

A 0.003 meter thick, 0.984 meters wide and 0.984 meters long annealed glass sheet was heat strengthened. A 0.003 meter thick glass, 1.000 meter wide and 1.000 meter long sheet of glass was heat strengthened. The sheets of heat strengthened glass were laminated together with a layer of Suntuitive® thermochromic interlayer available from Pleotint, LLC of Jenison, Mich. with the glass sheets positioned to provide a 0.008 meter wide offset or ledge in both width and length directions between the sheets of glass. A 0.003 meter thick, 0.984 meters wide and 0.984 meters long triple silver low-e coated annealed glass was laminated in a vacuum bag procedure to a 0.003 meter thick, 1.000 meter wide and 1.000 meter long sheet of annealed glass with a multilayer interlayer that comprised a layer of TPU, a PDLC device which had two transparent conductive layers of PET bonded together with a liquid crystal containing layer and another layer of TPU. The TPU layers served to bond the PDLC device to the sheets of glass. The low-e surface was on the exposed side of the 0.984 meters wide and 0.984 meters long sheet of glass after lamination. A warm edge spacer about 0.011 meters thick was made from spacer material from Technoform Glass Insulation North America of Twinsburg, Ohio with the proper dimension for bonding the inboard sheets of the laminates together. A bead of polyisobutylene was applied to each side of the spacer and it was used to bond to the inboard glass sides of the laminates as shown in FIG. 3. This formed a gas space of about 0.011 meter thick between the laminates with the low-e coating in contact with the gas space. The approximately 0.008 meter deep gap or trough between the cut edges of the outboard sheets of glass of the laminates and the spacer was filled all the way around the IGU with two component polysulfide from Fenzi North America of Toronto, Ontario which provided edge seal protection for the interlayers and dynamic materials of both laminates. The window glass unit was installed in a frame and the PDLC device was connected to a source of power in the usual manner. The window glass unit was used to provide both solar control via the thermochromic containing laminate and privacy via the PDLC device. In this window glass unit structure the seals provide excellent durability, the thermochromic layer provides UV barrier protection for the PDLC device and the low-e coating and this innovative structure provide a heat barrier for the overheating of the PDLC device which could compromise its performance.

### EXAMPLE 6

A 0.003 meter thick, 0.629 meters wide and 0.759 meters long glass sheet was heat strengthened. A 0.003 meter thick, 0.527 meters wide and 0.657 meters long glass sheet was heat strengthened. These sheets of glass were laminated together with a layer of Suntuitive® thermochromic interlayer about 0.527 meters wide and 0.657 meters long available from Pleotint, LLC of Jenison, Mich. The glass sheets and interlayer were positioned to provide an approximately 0.051 meter wide offset or ledge in both width and length directions between the sheets of glass. A warm edge spacer about 0.014 meters thick was made from spacer material from Technoform Glass Insulation North America of Twinsburg, Ohio with the proper dimension for bonding the outboard sheet of the laminate to a 0.003 meter thick, 0.629 meters wide and 0.759 meters long sheet of double silver low-e coated glass. The low-e coating was edge deleted so that the spacer could be bonded to the uncoated glass surface rather than to the low-e coating. The spacer was sized so that there was a gap of about 0.035 meters like that shown as 180 in FIG. 8 between the spacer and the inboard sheet of the laminate. A bead of polyisobutylene was applied to each side of the spacer and it was used to bond the outboard glass of the laminate to the low-e coating deleted portion of the 0.003 meter thick sheet of glass with the low-e coating about 0.008 meters from the cut edges of the outboard sheet and the 0.003 low-e coated sheet of glass. This formed a gas space of about 0.011 meter thick between the inboard sheet of the laminate and the coated side of the low-e coated sheet of glass. The approximately 0.008 meter deep gap or trough between the cut edges of the outboard sheets of glass and the spacer was filled all the way around the IGU with two component polysulfide from Fenzi North America of Toronto, Ontario. When this window structure is placed in a normal window frame for this size glass unit and the Suntuitive interlayer is heated by exposure to sunlight the gap between the spacer and the laminated area of the outboard laminate pane is effective in minimizing the heating of the window frame material.

Having described the invention in detail and by reference to preferred embodiments thereof, it will be apparent that modifications and variations are possible without departing from the scope of the invention as defined by the following claims.

What is claimed is:

1. An insulated glass unit comprising:
A first pane comprising an outboard sheet, an inboard sheet, and an interlayer therebetween, wherein the inboard sheet is smaller in length and/or width than the outboard sheet; and
a second pane spaced away from and sealed to the first pane;
a gas space between the inboard sheet of the first pane and the second pane;
a spacer positioned between the first pane and the second pane, wherein the spacer is adhered to the inboard sheet of the first pane and to the second pane with a primary seal; and
a second seal that adheres the outboard sheet of the first pane to the second pane.

2. The insulated glass unit of claim 1, wherein the inboard sheet is smaller than the outboard sheet in length and width.

3. The insulated glass unit of claim 2, wherein the outboard sheet and the inboard sheet are generally concentrically positioned relative to each other.

4. The insulated glass unit of claim 1, further comprising an interlayer primary seal positioned such that it seals an edge of the interlayer between the outboard sheet and the inboard sheet of the first pane.

5. The insulated glass unit of claim 4, wherein the interlayer primary seal extends along an edge of the inboard sheet and further extends along at least a portion of a spacer positioned between the inboard sheet and the second pane.

6. The insulated glass unit of claim 5, wherein the interlayer primary seal further extends to the second pane.

7. The insulated glass unit of claim 1, wherein the second pane comprises a second outboard sheet, a second inboard sheet, and a second interlayer therebetween, wherein the second inboard sheet is smaller in length and/or width than the second outboard sheet, and wherein the gas space is between the inboard sheet of the first pane and the inboard sheet of the second pane.

8. The insulated glass unit of claim 1, wherein the inboard sheet is thin annealed glass.

9. The insulated glass unit of claim 1, wherein the interlayer comprises a chromogenic material.

10. The insulated glass unit of claim 9, wherein the interlayer comprises a ligand exchange thermochromic system.

11. An insulated glass unit comprising:
a. a first glass substrate;
b. a first thermochromic layer;
d. a separator for thermochromic layers;
d. a second thermochromic layer;
e. a second glass substrate;
f. a gas space;
g. a low-e coating;
h. a third glass substrate;
i. a first adhesive interlayer;
j. a first plastic substrate;
k. a first transparent conductor layer;
l. a liquid crystal comprising layer;
m. a second transparent conductor layer;
n. a second plastic substrate;
o. a second adhesive interlayer; and
p. a fourth glass substrate;
wherein the first and second glass substrates are independently selected from chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the third and fourth glass substrates are independently selected from annealed, chemically strengthened, heat strengthened or tempered soda lime glass and untreated or chemically strengthened borosilicate, alkali-boroaluminosilicate, boroaluminosilicate, aluminosilicate or alkali-aluminosilicate glass and wherein the first and second thermochromic layers comprise at least two different ligand exchange thermochromic materials and/or systems and wherein the separator for thermochromic layers is selected from a layer of polyester, polyethylene terephthalate, polyethylene naphthalate, acrylic, glass and cyclic olefin polymer or copolymer and wherein the gas space comprises air, nitrogen, argon, krypton, sulfur hexafluoride and/or carbon dioxide and wherein the low-e coating comprises a transparent metal oxide layer and/or thin layers of silver or silver alloys and wherein the first and second adhesive interlayers are independently selected from polyvinylbutyral, thermoplastic polyurethane, ethylene vinyl acetate, ionomers and ionomers comprising metal ions and silicone and wherein the a first and second plastic substrates are independently selected from layers of polyester, polyethylene terephthalate, polyethylene naphthalate, acrylic and cyclic olefin polymer or copolymer and wherein the first and second transparent conductor layers are independently selected from one layer or a stack of layers of fluorine doped tin, fluorine doped zinc oxide, tin doped indium oxide (ITO), aluminum doped zinc oxide, silver and alloys of silver and wherein the liquid crystal comprising layer comprises cholesteric and/or nematic liquid crystals in droplets or small domains within a polymer matrix or network and wherein the thermochromic layers provide UV barrier protection for the liquid crystal containing layer and the low-e coating provides a heat barrier for the PDLC.
